(19) United States
(12) Patent Application Publication
(10) Pub. No.: US 2008/0070142 A1
(43) Pub. Date: Mar. 20, 2008

(54) Toner for electrostatic charge development, and developer for electrostatic charge development using the same, developer cartridge for electrostatic charge development and image forming apparatus

(75) Inventors: Makoto Furuki, Ashigarakami-gun (JP); Minquan Tian, Ashigarakami-gun (JP); Miho Watanabe, Ashigarakami-gun (JP); Takashi Matsubara, Ashigarakami-gun (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/704,989

(22) Filed: Feb. 12, 2007

(30) Foreign Application Priority Data
Sep. 20, 2006 (JP) 2006-254825
Sep. 20, 2006 (JP) 2006-254827

(51) Int. Cl. G03G 9/08

(52) U.S. Cl. 430/108.22; 430/111.4; 430/108.1

(57) ABSTRACT

The invention provides a toner for electrostatic charge development including a binder resin and an infrared absorber, wherein at least one of the infrared absorbers is a compound represented by Structural Formula (1).

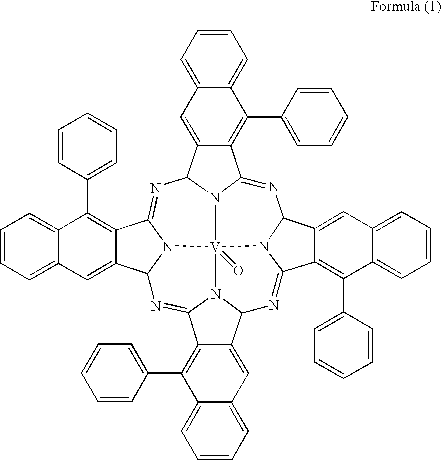

### CROSS-REFERENCE TO RELATED APPLICATIONS

This application is based on and claims priority under 35 USC 119 from Japanese Patent Application Nos. 2006-254827 and 2006-254825 both filed Sep. 20, 2006.

### BACKGROUND

1. Technical Field

The present invention relates to a toner for electrostatic charge development, capable of being utilized in electrophotographic apparatuses making use of an electrophotographic process or electrostatic process, such as a copier, printer or facsimile, and a developer for electrostatic charge development using this toner, a developer cartridge for electrostatic charge development and an image forming apparatus.

2. Background Art

Attention has been paid to technology embedding invisible information on paper for the purpose of security enhancement and integration with electronic environments. Specific examples of invisible information include information patterns having some specific information such as personal information and non-information patterns such as detection marks. The information patterns may include, for example, code patterns. The code patterns may include bar codes, for example, and the bar codes include, in addition to one-dimensional bar codes, two-dimensional bar codes and the like. A detection mark refers to a mark provided for setting of sheet feed timing of a transparent sheet, which is not detected optically, when an image is formed by means of a copier using an optical detection method.

Additionally, the formation of an infrared ray absorbing pattern by use of a machine capable of on-demand printing such as a copier also makes it possible to print an ID number or a coordinate on an individual document, and the like.

Moreover, reading of this invisible information generally uses an infrared ray absorbing pattern detector or the like. As a light source in an infrared ray absorbing pattern detector, an infrared ray light source such as a conventionally known infrared LED (light emitting diode) or an infrared laser can be directly used. As a detector for an infrared ray absorbing pattern, for example, a CCD sensor may also be used.

### SUMMARY

According to an aspect of the invention, there is provided a toner for electrostatic charge development comprising

a binder resin and at least one infrared absorber, wherein

at least one of the infrared absorbers is a compound represented by the following Structural Formula (1) below.

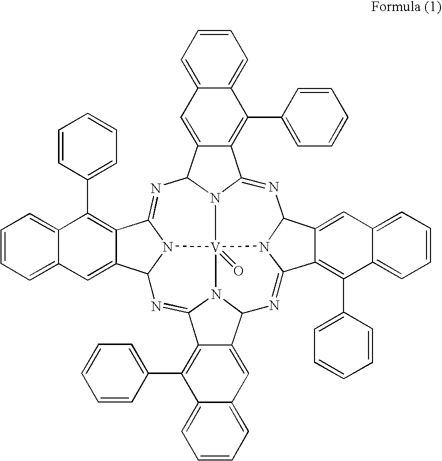

### BRIEF DESCRIPTION OF THE DRAWINGS

The present invention will be illustrated with reference to the following drawings illustrating embodiments of the invention wherein:

FIG. 1 is a sectional view schematically indicating a fundamental configuration of a suitable embodiment of an image forming apparatus of the invention;

FIG. 2 is a drawing of a reflectance spectrum of the image formed through the use of Toner A in Example 1;

FIG. 3 is a drawing of a reflectance spectrum of the image formed through the use of Toner B in Example 2;

FIG. 4 is a drawing of a reflectance spectrum of the image formed through the use of Toner P in Comparative Example 1;

FIG. 5 is a drawing of an absorption spectrum of an n-butoxy substituted naphthalocyanine (H₂NPc-OnBu) represented by Structural Formula (3) above;

FIG. 6 is a drawing of an absorption spectrum of an n-butoxy substituted vanadylnaphthalocyanine (VONPc-OnBu) represented by Formula (4) above;

FIG. 7 is a drawing of an absorption spectrum of a compound (ST173) represented by Structural Formula (8) above;

FIG. 8 is a drawing of an absorption spectrum of a compound (CR44(OH)₂) represented by Structural Formula (9) above; and

FIG. 9 is a drawing of an absorption spectrum of a unsubstituted vanadylnaphthalocyanine (VONPc) represented by Structural Formula (10) above.

### DETAILED DESCRIPTION

The invention will be set forth in detail hereinafter. Additionally, of the toners for electrostatic charge development of the invention, the toner according to the first aspect is particularly described by a toner 1 for electrostatic charge development (Toner 1), the toner according to the second aspect is particularly described by a toner 2 for electrostatic charge development (Toner 2), and a toner commonly according to the first and second aspects is simply described by a toner (toner) for electrostatic charge development.

### [1] Toner 1 for Electrostatic Charge Development

A toner 1 for electrostatic charge development of the invention (hereinafter may be abbreviated as Toner 1) contains at least a binder resin and an infrared absorber. In addition, the infrared absorber contains a “compound represented by Structural Formula (1)” below, and as required, in addition thereto, may contain additives such as a releasing agent. A toner 1 of the invention may be utilized in an invisible toner.

Herein, the term “invisible” refers to being scarcely recognized visually.

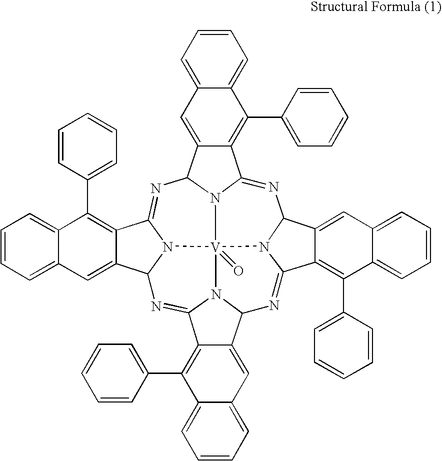

A “compound represented by Structural Formula (1)” above hardly absorbs visible light of wavelengths of from 400 to 700 nm, and very strongly absorbs a near infrared ray of a wavelength (850 nm) frequently used as an infrared ray absorption pattern detecting unit. Accordingly, an infrared ray absorption pattern formed through the use of a toner 1 containing an infrared absorber containing a “compound represented by Structural Formula (1)” above is scarcely recognized by human sight, and may be readily read out by means of an infrared ray absorption pattern detector.

Each composition component will be set forth hereinafter.

### <Infrared Absorber>

An infrared absorber used in Toner 1 of the invention contains, as described above, a “compound represented by Structural Formula (1)” above.

The volume average particle diameter of an infrared absorber containing a “compound represented by Structural Formula (1)” is preferably 0.3 μm or less, more preferably 0.05 μm or more and 0.2 μm or less, and still more preferably 0.08 μm or more and 0.15 μm or less. When the volume average particle diameter of an infrared absorber is greater than 0.3 μm, the volume average particle diameter of the infrared absorber is larger than the length of one fourth of the maximum absorption wavelength (850 nm) in the near infrared region of a “compound represented by Structural Formula (1)” contained in the infrared absorber, whereby the deterioration of the absorption contrast and the broadening of the absorption spectrum width, due to light scattering, are not sometimes negligible. Furthermore, when the volume average particle diameter of an infrared absorber is smaller than 0.05 μm, secondary aggregation is readily induced possibly.

Here, the volume average particle diameter of an infrared absorber is measured by means of a laser diffraction particle size distribution measuring apparatus (trade name: A-700, manufactured by Horiba, Ltd.). A method of measurement involves preparing about 2 g of an infrared absorber in terms of a solid, which is in the form of a dispersion solution, adding ion exchanged water thereto to 40 ml, placing the resulting solution into a cell to an appropriate concentration, allowing it to stand for two minutes, and then measuring the solution in the cell the concentration of which is substantially stable. A volume average particle diameter obtained for every channel is accumulated in the order of a small volume average particle diameter, and is defined as the volume average particle diameter when the accumulation is 50%.

The content of an infrared absorber is preferably 0.1 mass % or more and 2 mass % or less, more preferably 0.2 mass % or more and 1 mass % or less, still more preferably 0.3 mass % or more and 0.7 mass % or less, based on the amount of Toner 1. Additionally, the content is most preferably anywhere about 0.5 mass %. When the content is less than 0.2 mass %, an infrared ray absorption pattern formed by use of a toner 1 of the invention is possibly difficult to read out by means of a machine. Moreover, the content of 1 mass % or more possibly has an effect on color in visible printing. However, the case capable of use of an infrared ray absorption pattern detector with higher sensitivity may be preferable even though the content is less than 0.2 mass %.

A method of preparing a “compound represented by Structural Formula (1)” above may utilize a general method of synthesis similar to a method for an infrared absorber, as conventionally used.

Specifically, for instance, a method of manufacturing a “compound represented by Structural Formula (1)” above may involve reacting 2,3-dicyano-1-phenylnaphthalene (dicyano compound indicated by Structural Formula (2) below) under basic conditions with vanadyl trichloride in an appropriate solvent (preferably in an organic solvent having a boiling point of 130° C. or higher) at 100 to 300° C. (more preferably 130 to 220° C.).

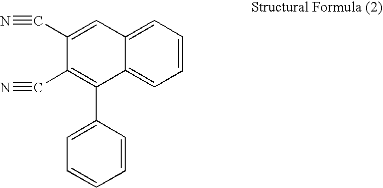

The amount of vanadyl trichloride that is used is preferably from 0.2 to 0.6 times (molar ratio), and more preferably from 0.25 to 0.4 times (molar ratio), the amount of 2,3-dicyano-1-phenylnaphthalene.

Here, solvents used in the reaction include organic solvents having a boiling point of 100° C. or higher, preferably 130° C. or higher. The examples include alcohol solvents such as n-amyl alcohol, n-hexanol, cyclohexanol, 2-methyl-1-pentanol, 1-heptanol, 2-heptanol, 1-octanol, 2-ethylhexanol, benzyl alcohol, ethylene glycol, propylene glycol, ethoxyethanol, propoxyethanol, butoxyethanol, dimethylaminoethanol and diethylaminoethanol, and high boiling-point solvents such as trichlorobenzene, chloronaphthalene, sulfolane, nitrobenzene, quinoline, N,N-dimethylformamide, N-methyl-2-pyrrolidone, N,N-dimethylimidazolidine, N,N-dimethylacetoamide and urea.

The amount of use of solvent is preferably from 1 to 100 times (mass ratio), more preferably from 5 to 20 times (mass ratio), the amount of 2,3-dicyano-1-phenylnaphthalene.

Additionally, as post-processing after completion of the reaction, by distillation removal of the solvent after the reaction, or by the filtration of deposits obtained by discharge of the reaction solution to a poor solvent to the compound, a target compound is obtained.

A method of converting a compound obtained into particles is not particularly limited if it is capable of pulverizing the compound to a particle state. A mechanical pulverizing method such as a hammer mill, an air collision pulverizing method such as a jet mill, and a wet pulverizing method such as an ultimizer, an atoliter and a wet ball mill may be used alone or in combination, and acid paste processing is preferably used for conversion of a compound into particles, for obtainment of an infrared absorber having a preferred volume average particle diameter.

Here, acid paste processing refers, specifically for example, to a technique of dissolving a resulting crude compound in an acid such as sulfuric acid or converting it into an acid salt such as a sulfate salt, and pouring the resulting substance into an aqueous alkaline solution, water, or ice water for recrystallization.

An acid used for acid pasting is preferably concentrated sulfuric acid. The concentration of concentrated sulfuric acid is preferably from 70 to 100%, more preferably from 95 to 100%. The amount of concentrated sulfuric acid is preferably set to be the range of from 20 to 500 times, more preferably from 50 to 200 times (each value being in terms of mass) the mass of the crystal of a resulting compound.

Additionally, the dissolving temperature is preferably set to be the range of from −20 to 100° C., more preferably from 0 to 60° C.

As a solvent when a crystal is precipitated out of an acid, water, or a mixture solvent of water and an organic solvent is used in an arbitrary amount. As a mixture solvent, a mixture solvent of water and alcohol-based solvent (e.g., methanol, ethanol, or the like) or of water and an aromatic solvent (e.g., benzene, toluene, or the like) is particularly preferred.

The temperature for precipitation is not particularly limited, and cooling by means of ice is preferred for the prevention of heat evolution.

Moreover, in a toner 1 of the invention, in addition to the infrared absorbers containing a “compound represented by Structural Formula (1)” above, other infrared absorbers may be used in combination. The other infrared absorbers include substances that show at least one strong light absorption peak in the near infrared region of the wavelength range of from 800 nm to 2000 nm. The infrared absorbers whether organic or inorganic substances are usable. The specific examples that are usable include known infrared absorbers and infrared absorbers containing therein, for example, a cyanine compound, merocyanine compound, benzenethiol-based metal complex, mercaptophenol-based metal complex, aromatic diamine-based metal complex, diimonium compound, aminium compound, nickel complex compound, phthalocyanine-based compound, anthraquinone-based compound, naphthalocyanine-based compound (excluding a “compound represented by Structural Formula (1)” above), or the like.

### [2] Toner 2 for Electrostatic Charge Development

A toner 2 for electrostatic charge development of the invention (hereinafter sometimes abbreviated as Toner 2) contains at least a binder resin and an infrared absorber, and may contain, in addition to these, an additive such as releasing agent, as required.

Moreover, a toner 2 of the invention may be utilized to an invisible toner. Herein, the term “invisible” refers to being hardly recognized visually.

At least one species of infrared absorbers contained in a toner 2 of the invention has a maximum absorption in the wavelength range of from 750 to 1100 nm, both inclusive.

The case where an absorption maximum wavelength of an infrared absorber is less than 750 nm has an effect on color in visible printing. Additionally, a generally used infrared ray detector (e.g., an Si photodiode, or the like) has bad sensitivity in the wavelength range of longer than 1100 nm. Hence, when an image is formed through the use of a toner containing an infrared absorber an absorption maximum wavelength of which is longer than 1100 mm, readability is worsened.

Moreover, an absorption maximum wavelength of an infrared absorber is preferably in the range of from 800 to 1000 nm, both inclusive. Because the transmittance wavelength range of a general light emitting diode used in an infrared ray absorption pattern detector, or the like is anywhere about 800 nm to about 1000 nm, the readability of an infrared ray absorption image in the case where an infrared ray absorption pattern detector is used is possibly worsened, when an absorption maximum wavelength of an infrared absorber is smaller than 800 nm or larger than 1000 nm. Furthermore, an absorption maximum wavelength of an infrared absorber is more preferably in the range of from 820 to 950 nm, both inclusive, most preferably near 850 nm. This is because an infrared ray absorption pattern detector using an infrared ray near 850 nm is most readily available.

The full width at half maximum of an infrared absorber in a wavelength range of from 750 nm to 1100 nm is 100 nm or less.

A light source used in an infrared ray absorbing pattern detector is, as described above, frequently a monochromatic light source such as an infrared LED (light emitting diode) or infrared laser. This is because absorption intensity in the wavelength of a monochromatic light used in an infrared ray absorbing pattern detector is comparatively low, when the full width at half maximum of a maximum absorption is larger than 100 nm, thereby worsening readability.

The full width at half maximum of a maximum absorption is preferably from 10 nm to 90 nm, both inclusive, and more preferably from 30 nm to 80 nm, both inclusive.

In addition, in Toner 2, the volume average particle distribution index GSD_{V} represented by Equation (X) below is 1.25 or less:

GSD_{V}=(D_{84V}/D_{16V})^{1/2} Equation (X)

wherein D_{84V} is a particle diameter value in which the accumulation from the small diameter side of the toner particle diameter distribution is 84%, and D_{16V} is a particle diameter value in which the accumulation from the small diameter side of the toner particle diameter distribution is 16%.

When the volume average particle distribution index GSD_{V} of Toner 2 is larger than 1.25, readability is deteriorated. The reason is estimated in the following.

Where the volume average particle distribution index GSD_{V} of Toner 2 is larger than 1.25, a time-lapse image area is widened after the infrared ray absorption image is formed on a recording medium, whereby the amount of infrared absorber contained in a unit area of the infrared ray absorption image is small. This lowers the infrared ray absorption intensity per area of the infrared ray absorption image, thereby deteriorating the readability in a lapse of time.

The volume average particle distribution index GSD_{V} of Toner 2 is preferably 1.23 or less, more preferably 1.21 or less.

Each composition component of Toner 2 will be described hereinafter.

### <Infrared Absorber>

At least one species of infrared absorbers used in a toner 2 of the invention has, as described above, a maximum absorption in the wavelength range of from 750 nm to 1100 nm, both inclusive, and the full width at half maximum of its maximum absorption is 100 nm or less.

The compounds exhibiting absorption spectra as indicated above include, for example, an n-butoxy-substituted naphthalocyanine represented by Structural Formula (3) (hereinafter sometimes abbreviated as “H₂NPc-OnBu”), an n-butoxy-substituted vanadyl naphthalocyanine in which M is VO in Formula (4) below (hereinafter sometimes abbreviated as “VONPc-OnBu”), an n-butoxy-substituted copper naphthalocyanine in which M is Cu in Formula (4) below (hereinafter sometimes abbreviated as “CuNPc-OnBu”), an n-butoxy-substituted nickel naphthalocyanine in which M is Ni in Formula (4) below (hereinafter sometimes abbreviated as “NiNPc-OnBu”), a phenyl-substituted vanadyl naphthalocyanine represented by Structural Formula (5) below (hereinafter sometimes abbreviated as “VONPc-Ph”), an i-butoxy/nitro-substituted copper naphthalocyanine represented by Structural Formula (6) below (hereinafter sometimes abbreviated as “CuNPc-OiBuNO₂”), a t-butyl-substituted vanadyl naphthalocyanine represented by Structural Formula (7) below (hereinafter sometimes abbreviated as “VONPc-tBu”), a compound represented by Structural Formula (8) below (hereinafter sometimes referred to as “ST173”), a compound represented by Structural Formula (9) below (hereinafter sometimes referred to as “CR44(OH)₂”), and the like.

Herein, the symbol “OBu” in Structural Formula (3) below and Formula (4) below means an “n-butoxy group,” and the symbol “OBu” in Structural Formula (6) means an “i-butoxy group.”

Additionally, the infrared absorbers are not limited thereto, and any compounds exhibiting the above-described spectrum may be used as well.

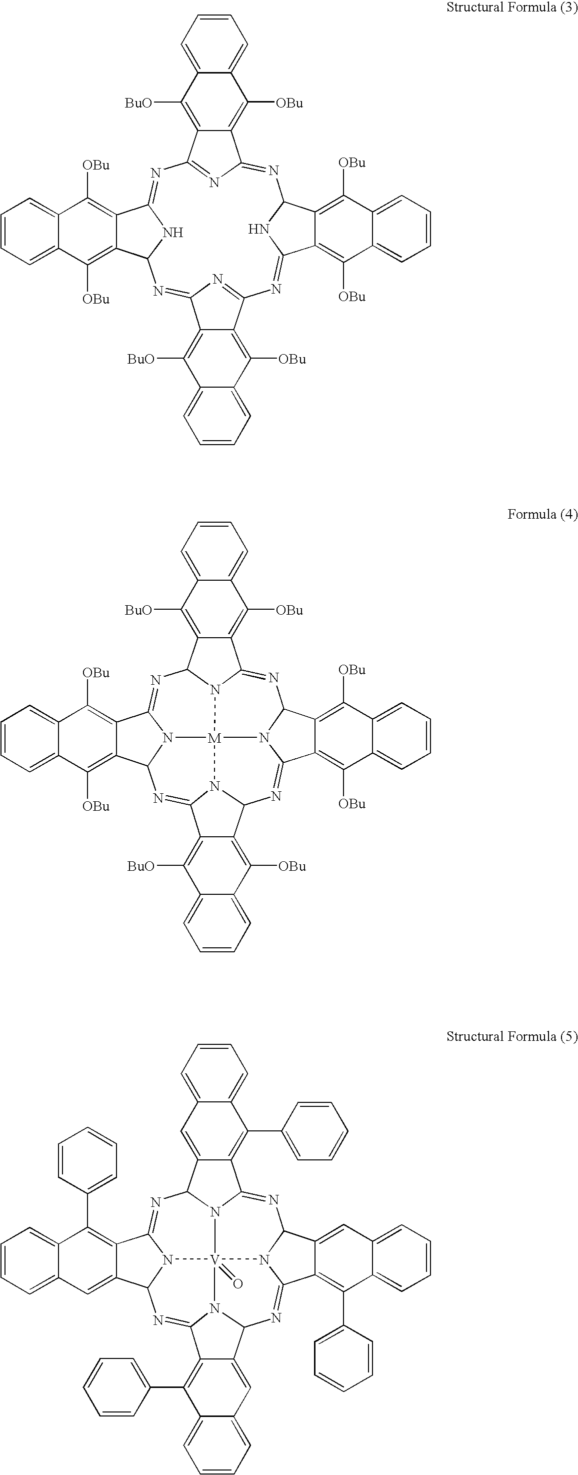

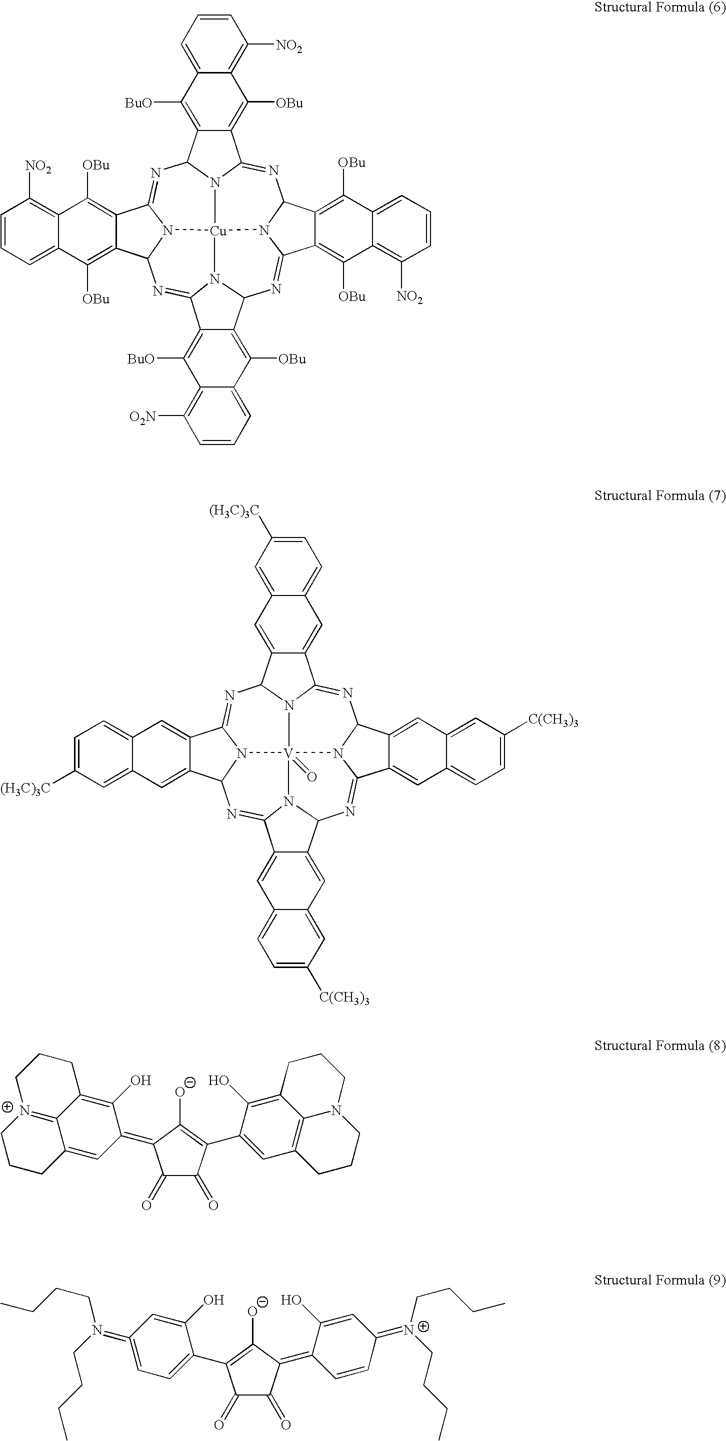

A maximum absorption wavelength of an infrared absorber and the full width at half maximum of the maximum absorption are evaluated from the absorption spectrum of a polystyrene acrylic film doped with a 0.2 weight % infrared absorber (hereinafter sometimes abbreviated as a “doped film”).

An absorption spectrum is, for example, measured in the following.

First, 0.5 mass parts of an infrared absorber and 99.5 mass parts of an acrylic polymerized resin (trade name: BR-83, manufactured by Mitsubishi Rayon Co., Ltd.) are admixed and the resulting mixture is dissolved in an organic solvent (e.g., tetrahydrofuran), whereby an infrared absorber dispersing coating solution is obtained.

Next, the infrared absorber dispersing coating solution is immersion applied onto a glass plate, and a doped film with a thickness of 3 μm is obtained.

An absorption spectrum of the doped film obtained as described above is obtained by means of a spectrophotometer (trade name: U-2000, manufactured by Hitachi Co., Ltd.)

Where an absorption spectrum thus obtained exhibits absorption maximum in the wavelength range of from 750 nm to 1100 nm, both inclusive, a wavelength indicating the maximum absorbance in the wavelength range of from 750 nm to 1100 nm, both inclusive, is defined as an “maximum absorption wavelength of the infrared absorber” and the difference of the wavelengths between two points taking the half valves of the maximum absorbance is defined as the “full width at half maximum of the maximum absorption of the infrared absorber.”

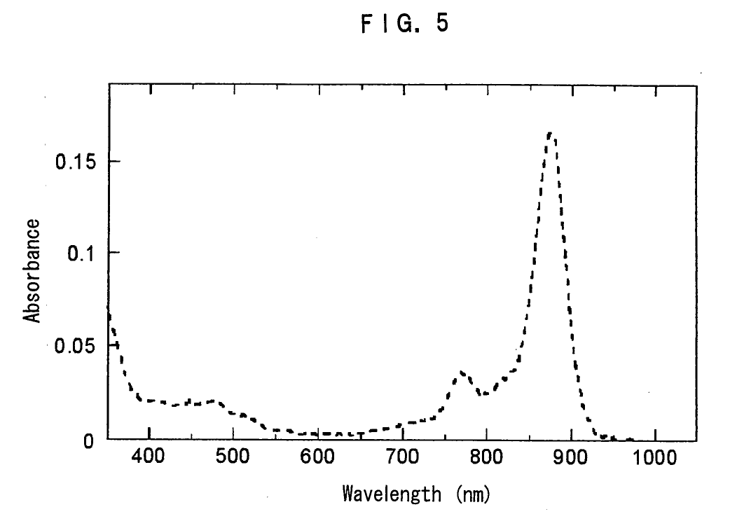

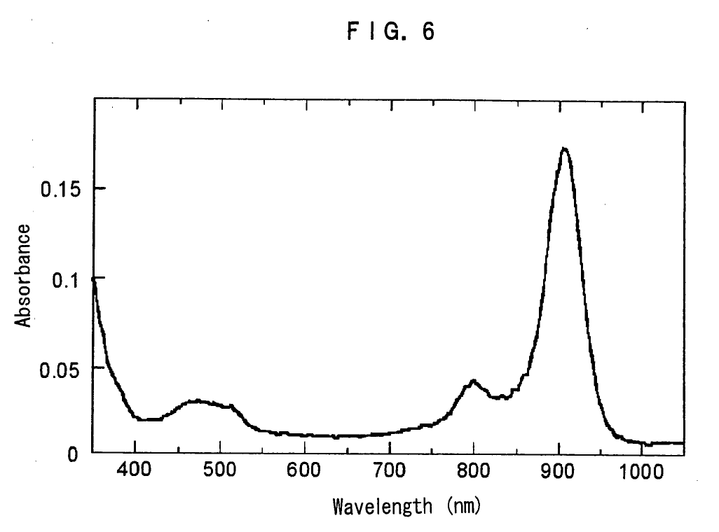

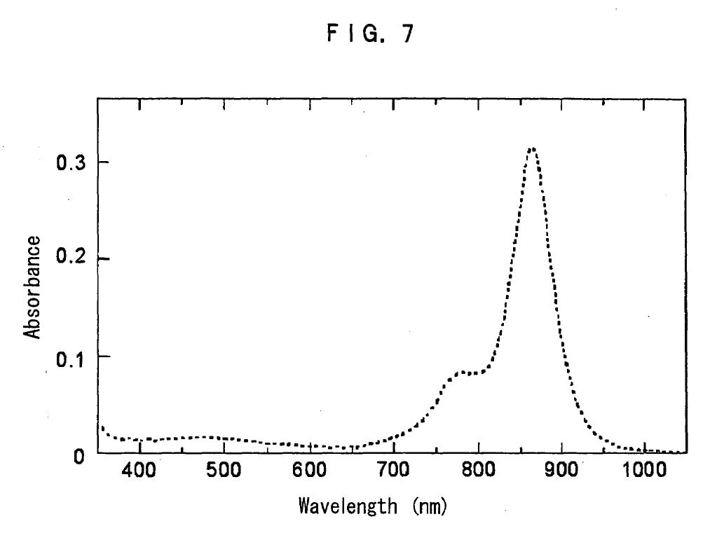

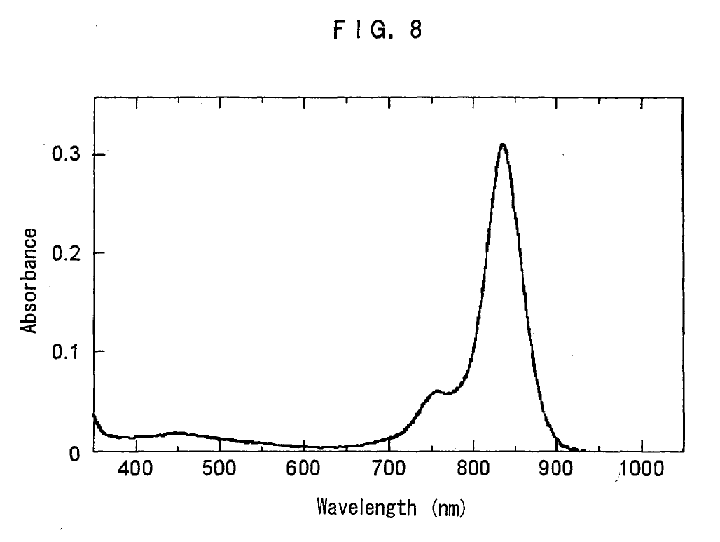

Absorption spectra of H₂NPc-OnBu, VONPc-OnBu, ST173 and CR44(OH)₂ obtained by measurement as described above are shown, respectively, in FIGS. 5 to 8.

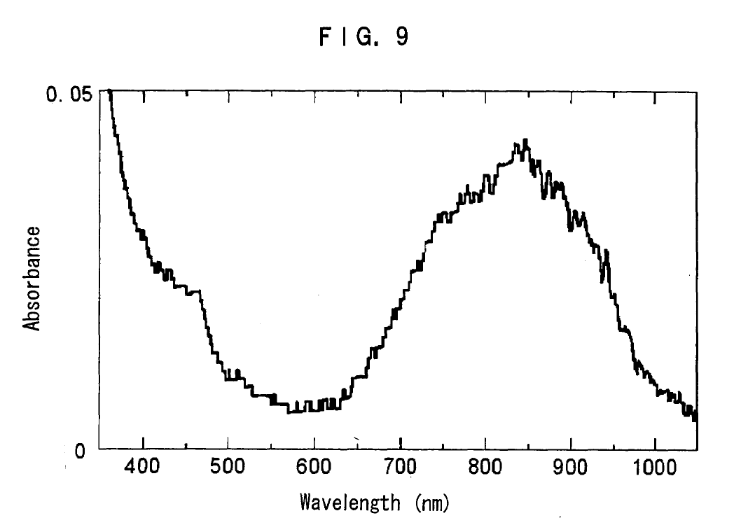

For comparison, an absorption spectrum of unsubstituted vanadyl naphthalocyanine represented by Structural Formula (10) below (hereinafter sometimes abbreviated as “VONPc”) is shown in FIG. 9.

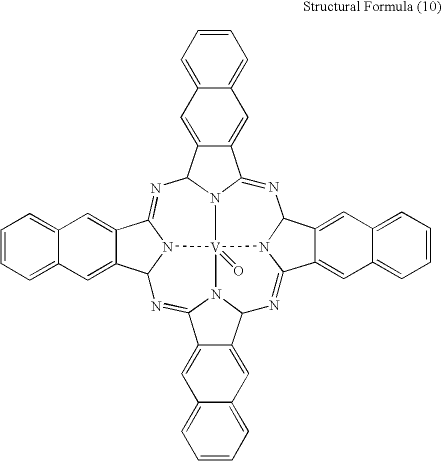

The “maximum absorption wavelengths” and the “full widths at half maximum of the maximum absorptions” of H₂NPc-OnBu, VONPc-OnBu, ST173 and CR44 (OH)₂ obtained by the absorption spectra of FIGS. 5 to 8 are listed in Table 1.

Additionally, the “maximum absorption wavelengths” and the “full widths at half maximum of the maximum absorptions” of CuNPc-OnBu, NiNPc-OnBu, VONPc-Ph, CuNPc-OiBuNO₂ and VONPc-tBu obtained by a similar method are listed in Table 1 as well.

For comparison, the “maximum absorption wavelength” and the “full width at half maximum of the maximum absorption” of VONPc are also listed in Table 1.

TABLE 1

| | | Full Widths at Half |
|---|---|---|
| | Maximum Absorption | Maximum of the |
| Compound Name | Wavelength (nm) | Maximum Absorption (nm) |
| H₂NPc-OnBu | 875 | 52 |
| VONPc--OnBu | 904 | 61 |
| CuNPc-OnBu | 855 | 55 |
| NiNPc-OnBu | 854 | 48 |
| VONPc-Ph | 843 | 45.5 |
| CuNPc-OiBuNO₂ | 864 | 45 |
| VONPc-tBu | 756 | 95 |
| ST173 | 861 | 61 |
| CR44(OH)₂ | 835 | 49.5 |
| VONPc | 836 | 250 |

The content of an infrared absorber is preferably 0.1 mass % or more and 2 mass % or less, more preferably 0.2 mass % or more and 1 mass % or less, still more preferably 0.3 mass % or more and 0.7 mass % or less, based on the amount of Toner 2. Additionally, the content is most preferably anywhere about 0.5 mass %. When the content is less than 0.2 mass %, an infrared ray absorption pattern formed by use of a toner 2 of the invention is possibly difficult to read out by means of a machine. Moreover, the content of 1 mass % or more possibly has an effect on color in visible printing. However, the case capable of use of an infrared ray absorption pattern detector with higher sensitivity may be preferable even though the content is less than 0.2 mass %.

The volume average particle diameter of an infrared absorber is preferably 0.8 μm or less, more preferably 0.6 μm or less, still more preferably 0.4 μm or less. This is because effective absorption of an infrared ray needs to have a larger surface area.

Additionally, the volume average particle diameter of an infrared absorber is preferably 0.05 μm or more. The reason is that when the volume average particle diameter of an infrared absorber is less than 0.05 μm, the particle diameter is too small relative to the wavelength of the infrared ray, whereby the sensitivity of the infrared ray absorption is sometimes lowered where the distribution of the amount of infrared absorber into Toner 2 is inhomogeneous.

Here, the volume average particle diameter of an infrared absorber is measured by means of a laser diffraction particle size distribution measuring apparatus (trade name: A-700, manufactured by Horiba, Ltd.). A method of measurement involves preparing about 2 g of an infrared absorber in terms of a solid, which is in the form of a dispersion solution, adding ion exchanged water thereto to 40 ml, placing the resulting solution into a cell to an appropriate concentration, allowing it to stand for two minutes, and then measuring the solution in the cell the concentration of which is substantially stable. A volume average particle diameter obtained for every channel is accumulated in the order of a small volume average particle diameter, and is defined as the volume average particle diameter when the accumulation is 50%.

Moreover, in a toner 2 of the invention, in addition to the above-described infrared absorber, other infrared absorbers may be used in combination. The other infrared absorbers include substances that show at least one strong light absorption peak in the near infrared region of the wavelength range of from 800 nm to 2000 nm. The infrared absorbers whether organic or inorganic substances are usable. The specific examples that are usable include known infrared absorbers and infrared absorbers containing therein, for example, a cyanine compound, merocyanine compound, benzenethiol-based metal complex, mercaptophenol-based metal complex, aromatic diamine-based metal complex, diimonium compound, aminium compound, nickel complex compound, phthalocyanine-based compound, anthraquinone-based compound, naphthalocyanine-based compound, or the like.

### <Binder Resins>

A toner of the invention may use a known binder resin.

Main components of the binder resin are preferably polyester and polyolefins, and a copolymer of styrene and acrylic acid or methacrylic acid, a copolymer of styrene and an acrylate ester or methacrylate ester, polyvinyl chloride, phenolic resin, acrylic resin, methacrylic resin, polyvinyl acetate, silicon resin, polyester resin, polyurethane, polyamide resin, furan resin, epoxy resin, xylene resin, polyvinyl butyral, terpene resin, cumarone-indene resin, petroleum-based resin, polyether polyol resin, and the like may be used alone or in combination. From the viewpoints of durability and translucency and the like, a polyester-based resin or norbornene polyolefin resin is preferably used.

The glass transition point (Tg) of a binder resin is preferably from 50 to 120° C., more preferably from 60 to 110° C. When the glass transition point is lower than 50° C., the storage stability or storage stability of the toner image after fixation sometimes poses a problem. When the glass transition point is higher than 120° C., the low-temperature fixing property is not sometimes obtained.

Here, the glass transition point (Tg) of a binder resin is determined by means of a differential scanning calorimeter (trade name: DSC-50, manufactured by Shimadzu Corporation) at a heating rate of 3° C. per minute, and is defined as the temperature of the intersection of the extension lines of the baseline and the rising line in an endothermic portion.

### <Other Components>

To a toner of the invention may be added another component as an additive selected as appropriate depending on its purpose, and not particularly limited.

However, an additive in a toner 1 of the invention is preferably an additive that does not cause the absorption of the toner to increase in visible light of the wavelengths of from 400 to 700 nm, considering the results of addition of additives.

Specifically, for example, to a toner of the invention may be added a releasing agent as required.

A releasing agent is not particularly limited, as long as it is a known releasing agent. The specific examples include ester waxes, polyethylene, polypropylene and a copolymer of polyethylene and polypropylene, which are most preferably used, and waxes such as polyglycerin waxes, microcrystalline waxes, paraffin waxes, carnauba waxes, Sasol waxes, montanate ester waxes, deacidificated carnauba waxes; saturated fatty acids such as palmitic acid, stearic acid, montanic acid; unsaturated fatty acids such as brassidic acid, eleostearic acid and valinaric acid; saturated alcohols such as stearin alcohol, aralkyl alcohol, behenyl alcohol, carnaubyl alcohol, ceryl alcohol, melissyl alcohol, or long-cahin alkyl alcohols having an alkyl group with a still longer chain; polyalcohols such as sorbitol; fatty amides such as linolic acid amide, oleic acid amide and lauric acid amide; saturated fatty acid bisamides such as methylene bisstearic acid amide, ethylene biscapric acid amide, ethylene bislauric acid amide and hexamethylene bisstearic acid amide; unsaturated fatty acid amides such as ethylene bisoleic acid amide, hexamethylene bisoleic acid amide, N,N′-dioleyladipic acid amide and N,N′-dioleylsebacic acid amide; aromatic bisamides such as m-xylene-bis-stearic acid amide and N,N′-distearylisophthalic acid amide; fatty acid metal salts (generally called metallic soaps) such as calcium stearate, calcium laurate, zinc stearate and magnesium stearate; waxes produced by grafting of a vinyl monomer such as styrene or acrylic acid on a fatty acid hydrocarbon-based wax; partial esterified substances of a fatty acid and polyalcohol such as behenic acid monoglyceride; methyl ester compounds having a hydroxyl group obtained by addition of hydrogen to vegetable fat and oil; and the like. These releasing agents may be used alone or in combination with two or more species.

The melting point of a releasing agent is preferably 50° C. or more, more preferably 60° C. or more. When the melting point of a releasing agent is lower than 50° C., the storage stability is possibly worsened, or blocking of the toner is possibly caused. The melting point of a releasing agent is, from the viewpoint of offset resistance, preferably 110° C. or less, more preferably 100° C. or less.

Here, the melting point of a releasing agent is determined by means of a differential scanning calorimeter (trade name: DSC-50, manufactured by Shimadzu Corporation) at a heating rate of 3° C. per minute and is defined as the temperature of the tip of an endothermic peak.

The content of a releasing agent is preferably within the range of 3 to 20 parts by weight, more preferably within the range of 5 to 18 parts by weight, based on 100 parts by weight of the binder resin. When the content of a releasing agent is less than 3 parts by weight based on 100 parts by weight of the binder resin, the addition of the releasing agent does not have an effect, and this sometimes causes hot-offset at a high temperature. On the other hand, when the content exceeds 20 parts by weight based on 100 parts by weight of the binder resin, the chargind property has an adverse effect. In addition thereto, since the mechanical strength of the toner is lowered, the toner is readily destroyed due to a stress within a developing apparatus, thereby sometimes causing spent carrier or the like.

Moreover, a toner 2 of the invention may contain a colorant. The colorant is not particularly limited, and any dyes, pigments or the like may be used. Examples of the color toner that is used include quinacridone (red), phthalocyanine (blue, etc.), anthraquinone (red), dysazo (red or yellow), monoazo (red), anilide-based compounds (yellow), benzidine (yellow), benzimidazolone (yellow), halogenated phthalocyanine (green), and the like. Black toners that are widely used may include black dyes and pigments such as carbon black, nigrosin dyes, ferrite and magnetite.

However, when a toner 2 of the invention is used as an invisible toner, a form of not containing a colorant is preferable.

In a toner of the invention, a mixture of the toner particles and white inorganic particles may be used for a flow improving agent or the like. The ratio of mixing of the white particles to the toner particles is preferably in the range of from 0.01 parts by weight to 5 parts by weight, both inclusive, is more preferably in the range of from 0.01 parts by weight to 2.0 parts by weight, both inclusive based on 100 parts by weight of toner particles. Such inorganic fine powders include, for example, a silica fine powder, alumina, titanium oxide, barium titanate, magnesium titanate, calcium titanate, strontium titanate, zinc oxide, silica sand, clay, mica, wollastonite, diatom earth, chromium oxide, cerium oxide, iron oxide red, antimony trioxide, magnesium oxide, zirconium oxide, barium sulfate, barium carbonate, calcium carbonate, silicon carbide, silicon nitride, and the like; from the viewpoint of not losing brightness, a silica fine powder the refraction index of which is smaller than the refraction index of a binder resin is particularly preferable. Additionally, a known material such as silica, titanium, a resin fine powder or alumina may be used together therewith. Furthermore, as a cleaning activator, a metal salt of a higher fatty acid as represented by zinc stearate or a powder of a fluorine-based high-molecular weight substance may be added thereto.

The silica particles may undergo a variety of surface treatments. Such surface treated silica particles that are preferably used include silica particles that are surface treated with, for example, a silane coupling agent, titanium coupling agent, silicone oil, or the like.

Moreover, to a toner of the invention may be added a charge controlling agent. The examples that may be used include known calixarenes, nigrosin-based dyes, quaternary ammonium salts, amino group-containing polymers, metal-containing azo dyes, complex compounds of salicylic acid, phenolic compounds, azo-chromium-based substances, azo-zinc substances, and the like.

Additionally, to the toner may be added, as required, a known external additive, and specifically the examples include inorganic particles, organic particles, and the like.

Inorganic particles used in the external additive include, for example, silica, alumina, titanium oxide, barium titanate, magnesium titanate, calcium titanate, strontium titanate, zinc oxide, silica sand, clay, mica, wollastonite, diatom earth, cerium chloride, iron oxide red, chromium oxide, cerium oxide, antimony trioxide, magnesium oxide, zirconium oxide, silicon carbide, silicon nitride, and the like. Of these, silica particles and titanium oxide particles are preferable, and hydrophobicity treated particles are particularly preferable.

Inorganic particles used in the external additive are generally used for the purpose of flow improvement. The primary particle diameter of inorganic particles (volume average particle diameter) is preferably in the range of from 1 nm to 200 nm, and the amount of addition thereof is preferably in the range of from 0.01 to 20 parts by weight based on 100 parts by weight of the toner particles.

Now, the volume average particle diameter of inorganic particles related to Toner 1 of the first aspect is measured by means of a laser diffraction particle size distribution measuring apparatus (trade name: LA-700, manufactured by Horiba, Ltd.). Specifically, a method of measurement involves, first, adding 2 g of a measurement sample to 50 ml of a 5% aqueous solution of a sodium alkylbenzenesulfonate of a surfactant, dispersing the resulting material by means of an ultrasonic dispersing apparatus (1,000 Hz) for two minutes for production of a specimen, placing the resulting specimen into a cell, allowing it to stand for two minutes, and then measuring the specimen in the cell the concentration of which is substantially stable. A volume average particle diameter obtained for every channel is accumulated in the order of a small volume average particle diameter, and is defined as the volume average particle diameter when the accumulation is 50%.

Here, the volume average particle diameter of inorganic particles related to Toner 2 of the second aspect may be determined by a method similar to the method of determining the volume average particle diameter in the above-described infrared absorber.

The organic particles are generally used for the purpose of improvement of cleaning and transfer properties, and specific examples thereof include polystyrene, polymethylmethacrylate, polyvinylidene fluoride, and the like.

### <Method of Manufacturing Toner 1>

With the production of a toner 1 of the invention, a generally used kneading pulverizing method, wet granulating method, or the like may be utilized. Herein, the wet granulating methods that may be used include a suspension polymerizing method, emulsification polymerizing method, emulsification polymerization aggregating method, soap-free emulsification polymerizing method, non water-dispersion polymerizing method, in-situ polymerizing method, interfacial polymerizing method, emulsification dispersion granulating method, and the like.

Production of a toner 1 of the invention by means of a kneading pulverizing method includes sufficiently mixing a binder resin and an infrared absorber and, as required, other additives, etc. via a Henschel mixer, ball mill or the like, melt kneading the resulting mixture by means of a heating kneader such as a heating roll, kneader, or extruder to render the resins to be mutually miscible, dispersing thereto or dissolving therein an infrared absorber, antioxidant, etc., and subsequently pulverizing or classifying the resulting material after cooling and solidification to be capable of obtaining Toner 1.

Where an infrared absorber is added to Toner 1, in addition to dispersion of the infrared absorber in the toner 1 for addition as described above, the infrared absorber may be adhered or fixed to the surfaces of the toner particles.

### <Method of Producing Toner 2>

A toner 2 of the invention is suitably produced by a wet producing method that forms toner particles in an acidic or alkaline waterborne medium, such as an aggregating/coalescing method, a suspension polymerizing method, a dissolution suspension granulating method, dissolution suspending method, dissolution emulsification aggregating/coalescing method, or the like, and an aggregating/coalescing method is preferred.

An aggregating/coalescing method suppresses the destruction of the ion balance of an aggregation system, thereby making the control of the aggregation speed easy; a suspension polymerizing method suppresses the generation of polymerization inhibition, thereby particularly rendering the control of the particle diameter easy; and a dissolution suspension granulating method or dissolution emulsification aggregating/coalescing method makes it possible to provide particle stabilization during granulation or emulsification.

An aggregating/coalescing method is a manufacturing method including an aggregating step of mixing, for example, a resin particle dispersion solution having dispersed therein polyester resin particles, an infrared absorber particle dispersion solution having dispersed therein infrared ray absorbing particles and a releasing agent particle dispersion solution having dispersed therein releasing agent particles for the formation of the aggregation particles of resin particles, infrared absorber particles and releasing agent particles; a stopping step of stopping aggregation growth by the adjustment of a pH within the aggregation system; and an amalgamating/coalescing step of heating the aggregation particles to a temperature of the glass transition point or higher of the resin particles for amalgamation and coalescence. In addition, an aggregating/coalescing method may also include, as required after the aggregating step, a shell forming step of adding other resin particles and causing the particles to adhere to the surfaces of the aggregation particles.

Specifically, the method involves admixing infrared absorber particle dispersion solution having dispersed therein infrared absorber particles, etc. via an ionic surfactant by use of a resin particle dispersion solution having dispersed therein resin particles by means of an ionic surfactant the charge of which is opposite to the charge of the above ionic surfactant for the formation of hetero aggregation, adding, as required, a dispersion solution of other resin particles to adhere and aggregate the other resin particles to the aggregation particle surfaces, stopping the aggregation growth for the formation of aggregation particles with the toner diameter, heating the aggregation particles to a temperature of the glass transition point or higher of the resin particles for the amalgamation and coalescence of the aggregates, and then washing and drying the resulting substance.

Each step in an example of the above-described aggregating/coalescing method will be set forth in detail hereinafter.

### (Aggregating Step)

In the aggregating step, first, a resin particle dispersion solution, an infrared absorber particle dispersion solution and a releasing agent particle dispersion solution are prepared.

The resin particle dispersion solution is produced by means of a known phase inversion method or a method of heating the resin particles to a temperature of the glass transition point or higher of the resin and then emulsifying the solution by means of mechanical shear force. At this time, an ionic surfactant may be added thereto.

The infrared absorber particle dispersion solution is prepared by dispersion of infrared absorber particles in a solvent by use of an ionic surfactant.

The releasing agent particle dispersion solution is prepared by the dispersion of a releasing agent in water together with a macromolecular electrolyte (e.g., an ionic surfactant, high molecular acid, high molecular base, or the like), by the heating of the releasing particles to the melting point or more of the releasing agent and also by the granulation by means of a homogenizer capable of high shear or a pressure discharge dispersing apparatus.

Next, a resin particle dispersion solution, an infrared absorber particle dispersion solution and a releasing agent particle dispersion solution are admixed, and then resin particles, colorant particles and releasing agent particles are hetero-aggregated for the formation of aggregated particles having a diameter substantially equal to the desired toner diameter (core aggregation particles).

### (Shell Forming Step)

The shell forming step involves adhering resin particles to the surfaces of core aggregation particles through the use of resin particle dispersion solution containing therein the resin particles to form a coated layer (shell layer) with a desired thickness and obtaining aggregation particles having a core/shell structure (core/shell aggregation particles) having the shell layer formed on the core aggregation particle surfaces.

Additionally, the aggregating step and shell forming step may also be separately repeated in stages plural times.

Here, the volume average particle diameters of resin particles, infrared ray absorbing particles and releasing agent particles, used in the aggregating step and the shell forming step, are preferably 1 μm or less, more preferably within the range of from 100 to 300 nm, for the purpose of the ease of adjustment of the toner diameter and particle size distribution to desired values.

The volume average particle diameters of these resin particles, infrared ray absorbing particles and releasing agent particles may be determined by means of a method similar to the method of determining the volume average particle diameter in the above-described infrared absorbing agent.

### (Stopping Step)

The stopping step involves adjusting pH within an aggregation system to stop the aggregation growth of the particles.

### (Amalgamating/Coalescing Step)

The fusing/coalescing step involves heating aggregation particles obtained through the aggregating step and the shell forming step carried out as required to the glass transition temperature or more of the resin particles contained in the aggregation particles, in the solution, and then amalgamating and coalescing the particles to obtain a toner.

Here, when two or more kinds of resins are present, the resins are heated to the glass transition temperature or more of a resin having the highest glass transition temperature.

### (Other Steps)

After completion of the aggregation and amalgamation, the desired toner is obtained via an arbitrary cleaning step, solid/liquid separating step and drying step. The cleaning step preferably involves sufficient substitution cleaning with ion exchange water from the viewpoint of charging properties. In addition, the solid/liquid separating step is not particularly limited, and suction filtration, pressure filtration or the like is preferably used from the viewpoint of productivity. Furthermore, the drying step is not particularly limited in its manner, and freeze drying, flash jet drying, fluidized drying, vibration fluidized drying, or the like is preferably used from the viewpoint of productivity.

### (Other Processes)

Additionally, the above-described aggregating/coalescing method may be sometimes carried out by collective mixing for aggregation. A specific example is a method of keeping the balance of the amount of each polar, ionic dispersing agent to shift in advance at an early stage of the aggregating step. More specifically, an example is a method of ionically neutralizing at least one species of the polymers of metal salts, forming a mother aggregate of a first stage at a temperature lower than the glass transition point, stabilizing the mother aggregation particles, adding a second-stage addition resin particle dispersion solution treated with a dispersing agent of a polarity and amount covering the balance shift as a second stage, slightly heating, as required, the solution at a temperature slightly lower than the glass transition point of the resin contained in the mother aggregation particles or the second-stage addition resin particle dispersion solution, raising the temperature for stabilization, and then heating the solution to the glass transition temperature or higher for coalescence while keeping the second-stage addition resin particles to adhere to the mother aggregation particle surfaces. Moreover, this step-by-step operation of aggregation may also be repeated plural times.

The polymer of a metal salt is suitably a polymer of a quadrivalent aluminum salt or mixture of a quadrivalent aluminum salt and a trivalent aluminum salt. Specifically, the examples include inorganic metal salts such as calcium nitrate or polymers of inorganic metal salts such as polyaluminum chloride. Additionally, the polymer of a metal salt is preferably added in such a way that the concentration of the polymer is from 0.11 to 0.25 weight % based on the total amount of particle dispersion solution.

When an infrared absorber is added to Toner 2, besides the addition of an infrared absorber to the inside of Toner 2 as described above, an infrared absorber may be adhered or fixed to the surface of toner particles.

### <Physical Properties of Toner 1>

In a toner 1 of the invention produced as described above, its volume average particle diameter (D_{50V}) is preferably within the range of from 3 μm to 10 μm, both inclusive, more preferably within the range of from 4 μm to 8 μm, both inclusive. Additionally, the ratio (D_{50V}/D₅₀ₚ) of the volume average particle diameter (D_{50V}) to the number average particle diameter (D₅₀ₚ) is preferably in the range of from 1.0 to 1.25. Use of a toner having such small particle diameters and matched particle diameters makes it possible to suppress the variation of charging performance of the toner, to reduce fogging in an image to be formed, and also to improve the fixing property of the toner. Moreover, fine-line reproducibility and dot reproducibility in an image to be formed may also be improved.

Here, when the volume average particle diameter and the number average particle diameter of a toner 1 are evaluated, the particle diameters were determined by means of a Coulter Multisizer II model (manufactured by Beckman Coulter, Inc.) as a measurement apparatus by use of an ISOTON-II (manufactured by Beckman Coulter, Inc.) as an electrolyte solution.

The measurement method involved adding 0.5 to 50 mg of a measurement sample to 2 ml of a 5% aqueous solution of a surfactant, preferably sodium alkylbenzenesulfonate as a dispersing agent, adding this resulting solution to 100 to 150 ml of the above-mentioned electrolyte, subjecting the electrolyte solution having therein suspended this measurement sample to dispersion treatment by means of an ultrasonic dispersing device for about one minute, and subsequently determining the particle size distribution of particles in the range of 2.0 to 60 μm by the above-mentioned Coulter Multisizer II model by means of an aperture having an aperture diameter of 100 μm. The number of particles to be measured was 50,000.

For the particle size distribution measured, the accumulation distribution is drawn on each of the volume and the number in the order of a small diameter side in the divided particle ranges (channel). The particle diameter in which the accumulation in volume is 50% is defined as the volume average particle diameter (D_{50V}).

On the other hand, when toner particles are produced by means of the above-mentioned wet granulating method, the shape factor SF1 of particles of Toner 1 is preferably in the range of from 110 to 135.

Herein, the above-mentioned toner shape factor SF1 is obtained in the manner of taking toner particles dispersed on a slide glass sheet or an optical microscope image of a toner through a video camera in a Luzex image analyzer, evaluating the largest lengths and the projection areas of 50 or more toners, performing the calculations by Equation (1) below, and evaluating their average value.

SF1=(ML²/A)×(π/4)×100 (1)

wherein ML denotes the largest length of a toner particle and A denotes the projection area of a toner particle.

### <Physical Properties of Toner 2>

In a toner 2 of the invention produced as described above, its volume average particle diameter (D_{50V}) is preferably within the range of from 3 μm to 10 μm, both inclusive, more preferably within the range of from 4 μm to 8 μm, both inclusive. Additionally, the ratio (D_{50V}/D₅₀ₚ) of the volume average particle diameter (D_{50V}) to the number average particle diameter (D₅₀ₚ) is preferably in the range of from 1.0 to 1.25. Use of a toner having such small particle diameters and matched particle diameters makes it possible to suppress the variation of charging performance of the toner, to reduce fogging in an image to be formed, and also to improve the fixing property of the toner. Moreover, fine-line reproducibility and dot reproducibility in an image to be formed may also be improved.

Herein, the methods of evaluating the volume average particle diameter (D_{50V}), the number average particle diameter (D₅₀ₚ) and the volume average particle size distribution (GSD_{V}) of Toner 2 are in the following.

To 2 ml of a 5% aqueous solution of a surfactant, preferably sodium alkylbenzenesulfonate as a dispersing agent is added 0.5 to 50 mg of a measurement sample, and the resulting solution is added to 100 to 150 ml of an electrolyte. As the electrolyte, ISOTON-II (manufactured by Beckman Coulter, Inc.) is used.

Next, the electrolyte solution having therein suspended this measurement sample is subjected to dispersion treatment for about one minute by means of an ultrasonic dispersing device, and then the particle size distribution of particles in the range of 2.0 to 60 μm is determined by a Coulter Multisizer II model (manufactured by Beckman Coulter, Inc.) as a measurement apparatus by means of an aperture having an aperture diameter of 100 μm. The number of particles to be measured is 50,000.

For the particle size distribution measured, an accumulation distribution is drawn on each of the volume and the number in the order of a small diameter side in the divided particle ranges (channel). The particle diameter in which the accumulation in volume is 50% is defined as the volume average particle diameter (D_{50V}), and the particle diameter in which the accumulation in number is 50% is defined as the number average particle diameter (D₅₀ₚ).

In a similar manner, the particle diameter in which the accumulation in volume is 16% is defined as the volume average particle diameter D_{16V}, the particle diameter in which the accumulation in volume is 84% is defined as the volume average particle diameter D_{84V}, and the volume average particle size distribution (GSD_{V}) is calculated from (D_{84V}/D_{16V})^{1/2}.

### [3] Developer for Electrostatic Charge Development

A developer for electrostatic charge development of the invention contains at least a toner 1 or 2 for electrostatic charge development of the invention and may also, as required, contain a carrier. A developer for electrostatic charge development of the invention (hereinafter sometimes abbreviated as a developer) will be set forth hereinafter.

The carrier is not particularly limited, and a known carrier may be used. The carriers may include, for example, resin coat carriers having a resin coated layer having the core surface coated with a coating resin. Additionally, the carriers may also include resin dispersion type carriers comprising a matrix resin having dispersed thereon an electric conductive material.

The coating resins and the matrix resins that are used for the carrier may include (but be not limited to), for example, polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylic acid copolymers, straight silicon resins consisting of organosiloxane linkage or modified products thereof, fluorine resins, polyester, polycarbonate, phenolic resins, epoxy resins, and the like.

The electric conductive materials may include (but be not limited to), for example, metals (e.g., gold, silver, copper, etc.), titanium oxide, zinc oxide, barium sulfide, aluminum borate, potassium titanate, tin oxide, and the like.

Cores of the carrier include magnetic oxides (e.g., ferrite, magnetite, and the like). glass beads, and the like; cores of the carrier are preferably magnetic materials, for use of the carrier in a magnetic brush method. The volume average particle diameter of the core of a carrier is preferably in the range of from 10 to 500 μm, more preferably in the range of from 30 to 100 μm.

Manners of resin coating on the surface of the core of a carrier include a method of coating by means of a coated layer forming solution produced by dissolution of a coating resin and as required various additives in an appropriate solvent. The solvent is not particularly limited, and may be selected as appropriate, considering a coating resin, coating suitability, etc.

The specific resin coating methods include (1) an immersing method of immersing the core of a carrier in a coated layer forming solution, (2) a spraying method of spraying a coated layer forming solution to the core surface of a carrier, (3) a fluidized bed method of spraying a coated layer forming solution to the core surface of a carrier in a floating state of the carrier via flow air, and (4) a kneader coater method of admixing the cores of a carrier and a coated layer forming solution in a kneader coater and then removing the solvent.

In a developer containing therein a carrier, the mixture ratio (weight ratio) of a toner to a carrier (toner:carrier) is preferably in the range of about 1:100 to about 30:100, more preferably in the range of about 3:100 to about 20:100.

### [4] Developer Cartridge for Electrostatic Charge Development and an Image Forming Apparatus

Next, a developer cartridge for electrostatic charge development of the invention (hereinafter sometimes abbreviated as a cartridge) will be described. A cartridge of the invention is attachable and detachable to and from an image forming apparatus and at least accommodates a developer provided for a developing unit disposed within the image forming apparatus; the developer is the above-mentioned developer of the invention.

Accordingly, in an image forming apparatus having a configuration in which the cartridge is attachable and detachable, the utilization of the cartridge of the invention accommodating a developer containing a toner 1 of the invention renders it possible to form an infrared ray absorbing pattern that is hardly visually recognized by humans and readily readable by means of an infrared ray absorbing pattern detector on the surface of a recording medium.

Alternatively, in an image forming apparatus having a configuration in which the cartridge is attachable and detachable, the utilization of the cartridge of the invention accommodating a developer containing a toner 2 of the invention renders it possible to form an infrared ray absorbing image that is good in readability and is hardly deteriorated in readability in a lapse of time on the surface of a recording medium.

Moreover, an image forming apparatus of the invention includes at least an electrostatic latent image supporter, an electrostatic latent image forming unit for forming an electrostatic latent image on the surface of an electrostatic latent image supporter, a developing unit for forming a toner image by the development of the electrostatic latent image with a developer, a transfer unit for transferring the toner image to a recording medium, and a fixing unit for fixing the above-mentioned toner image on the recording medium; the developer is the above-mentioned developer for the electrostatic charge development of the invention.

Accordingly, the utilization of an image forming apparatus of the invention using a developer containing a toner 1 of the invention makes it possible to form an infrared ray absorbing pattern that is hardly visually recognized by humans and readily readable by means of an infrared ray absorbing pattern detector on the surface of a recording medium.

Alternatively, the utilization of an image forming apparatus of the invention using a developer containing a toner 2 of the invention makes it possible to form an infrared ray absorbing image that is good in readability and is hardly deteriorated in readability in a lapse of time on the surface of a recording medium.

In addition, an image forming apparatus of the invention is not particularly limited as long as it includes at least an electrostatic latent image supporter, an electrostatic latent image forming unit, a developing unit, a transfer unit and a fixing unit, as mentioned above, and may include other units.

A cartridge and an image forming apparatus of the invention will be specifically set forth with reference to a drawing hereinafter.

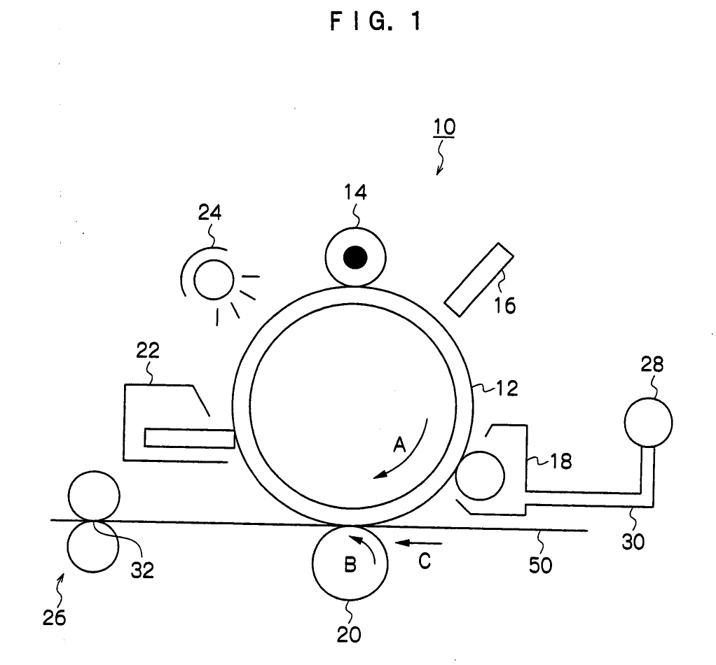

FIG. 1 is a sectional view schematically indicating a fundamental configuration of a preferable embodiment of an image forming apparatus of the invention. An image forming apparatus 10 shown in FIG. 1 includes an electrostatic latent image supporter 12, a charging unit 14, an electrostatic latent image forming unit 16, a developing unit 18, a transfer unit 20, a cleaning unit 22, a charge removing unit 24, a fixing unit 26 and a cartridge 28.

Additionally, the developer housed in the developing unit 18 and the cartridge 28 is the developer of the invention.

Although FIG. 1 only shows the developing unit 18 and the cartridge 28 housing the developer of the invention, in addition thereto, a configuration is also possible in which a developing unit and a cartridge accommodating another developer are simultaneously provided.

The image forming apparatus shown in FIG. 1 is an image forming apparatus having a configuration in which attaching and detaching of the cartridge 28 are possible, and the cartridge 28 is connected to the developing unit 18 by way of a developer supplying tube 30. Hence, when an image is formed, the developer of the invention housed in the cartridge 28 is supplied to the developing unit 18 by way of the developer supplying tube 30, whereby it is possible to carry out image formation using the developer of the invention for a long period of time. When the amount of the developer accommodated in the cartridge 28 becomes small, this cartridge may be changed.

Around the periphery of the electrostatic latent image supporter 12, the charging unit 14 for uniformly charging the surface of the electrostatic latent image supporter 12, the electrostatic latent image forming unit 16 for forming an electrostatic latent image on surface of the electrostatic latent image supporter 12 corresponding to image information, the developing unit 18 for supplying the developer of the invention to the formed electrostatic latent image, the drum-shaped transfer unit 20 capable of driven rotation in the arrow B direction in contact with the electrostatic latent image supporter 12 along with the rotation of the electrostatic latent image supporter 12 in the arrow A direction, the cleaning apparatus 22 contacting with the surface of the electrostatic latent image supporter 12 and the charge removing unit 24 for removing the charge on the surface of the electrostatic latent image supporter 12 are disposed along the rotational direction (direction of the arrow A) of the electrostatic latent image supporter 12, in that order.

between the electrostatic latent image supporter 12 and the transfer unit 20 The recording medium 50 delivered in the arrow C direction by means of a delivering unit (not shown) from the side opposite to the arrow C direction can be inserted through between the electrostatic latent image supporter 12 and the transfer unit 20. The fixing unit 26 housing a heating source (not shown) is disposed on the arrow C direction side of the electrostatic latent image supporter 12, and a pressure contact portion 32 is disposed in the fixing unit 26. Additionally, the recording medium 50 passed through between the electrostatic latent image supporter 12 and the transfer unit 20 can be inserted through this pressure contacting portion 32 in the arrow C direction.

As the electrostatic latent image supporter 12, for example, a photoreceptor, dielectric recording body, or the like may be used.

As the photoreceptor, for example a photoreceptor having a monolayer structure, a photoreceptor having a multilayer structure, or the like may be used. As materials of a photoreceptor, inorganic photoreceptor materials of selenium, amorphous silicon, etc., organic photoreceptor materials, and the like are considered for use.

The charging unit 14 may make use of a known unit such as, for example, a contact charging apparatus using a roller, brush, film, rubber blade or the like, with electric conductivity or semiconductivity, or a non-contact type charging apparatus of, for example, corotoron charging or scorotoron charging utilizing corona discharging.

The electrostatic latent image forming unit 16 may also use, in addition to an exposing unit, any conventionally known unit such as being capable of forming a signal capable of forming a toner image at a desired position on the surface of a recording medium.

The exposing unit may utilize a conventionally known exposing unit such as, for example, a combination of a semiconductor laser and a scanning apparatus, a laser scanning writing apparatus comprising an optical system or a LED head. For the purpose of achievement of a preferred aspect of creating an exposing image with high resolution, a laser scanning writing apparatus or LED head is preferably used.

The transfer unit 20 may make use of a conventionally known unit of, specifically for example, a unit of creating an electric field between the electrostatic latent image supporter 12 and the recording medium 50 by means of an electric conductive or semiconductive roller, brush, film, rubber blade or the like, applied by an electric filed, and transferring a toner image consisting of charged toner particles, and a unit of corona charging the back face of the recording medium 50 by means of a corotoron charger or scorotoron charger utilizing corona discharging and transferring a toner image consisting of charged toner particles.

Additionally, the transfer unit 20 may also employ a secondary transfer unit. In other words, the secondary transfer unit (not shown) is a unit of once transferring a toner image to an intermediate transfer body and then secondarily transferring the toner image from the intermediate transfer body to the recording medium 50.

The cleaning units 22 include, for example, a cleaning blade, cleaning blush, and the like.

The static charge removing units 24 include, for example, a tungsten lamp, a LED, and the like.

The fixing unit 26 may make use of, for example, a heating fixing device of fixing a toner image by heating pressure application, such as consisting of, for example, a heating roller and a pressure applying roll, an optically fixing device of heating a toner image by light radiation with a flush lamp or the like for fixation, or other units.

The recording medium 50 is not particularly limited, and may utilize a conventionally known medium including plain paper, or glossy paper. Additionally, the recording medium may also make use of a medium having an image receiving layer formed in and on top of a substrate.

Next, image formation using the image forming apparatus 10 will be described. A toner image is formed by, first, charging the surface of the electrostatic latent image supporter 12 by means of the charging unit 14 along with the rotation of the electrostatic latent image supporter 12 in the arrow A direction, forming an electrostatic latent image corresponding to image information on the surface of the charged electrostatic latent image supporter 12 via the electrostatic latent image forming unit 16, and then supplying the developer of the invention from the developing unit 18 to the surface of the electrostatic latent image supporter 12, corresponding to the color information of the electrostatic latent image.

Next, the toner image formed on the surface of the electrostatic latent image supporter 12 is moved to the contact portion of the electrostatic latent image supporter 12 and the transfer unit 20 along with the rotation of the electrostatic latent image supporter 12 in the arrow A direction. At this time, the recording medium 50 is inserted through the contact portion in the arrow C direction by means of a sheet delivering roll (not shown), and then the toner image formed on the surface of the electrostatic latent image supporter 12 is transferred to the surface of the recording medium 50 at the contact portion by a voltage applied between the electrostatic latent image supporter 12 and the transfer unit 20.

The toner remaining on the surface of the electrostatic latent image supporter 12 after the transfer of the toner image to the transfer unit 20 is removed with the cleaning blade of the cleaning unit 22, and the charge thereon is removed by the charge removing unit 24.

The recording medium 50, to the surface of which the toner image has been transferred in this manner, is delivered to the pressure contact portion 32 of the fixing unit 26 and is heated, upon passing through the pressure contact portion 32, by the fixing unit 26 in which a surface thereof at the pressure contact portion 32 has been heated by a built-in heating source (not shown). At this time, an image is formed by fixation of the toner image on the surface of the recording medium 50.

### EXAMPLES

The present invention will be described in detail by way of examples hereinafter; however, the invention is by no means limited to the examples only.

### [Measurement Method]

### <Method of Measuring the Volume Average Particle Diameter (in the Case where the Particle Diameter to be Measured is 2 μm or More)>

When the particle diameter to be measured is 2 μm or more, as described above, the volume average particle diameter of particles is measured by means of Coulter Multisizer II (manufactured by Beckman-Coulter, Inc.) measurement apparatus. As an electrolyte solution, an ISITON-II (manufactured by Beckman Coulter, Inc.) is used.

The measurement method involves adding 0.5 to 50 mg of a measurement sample to 2 ml of a 5% aqueous solution of a surfactant, preferably sodium alkylbenzenesulfonate, as a dispersing agent, adding this solution to 100 to 150 ml of the above-mentioned electrolyte, subjecting the electrolyte solution having therein suspended this measurement sample to dispersion treatment for about one minute by means of an ultrasonic dispersing device, and then determining the particle size distribution of particles in the range of 2.0 to 60 μm by the above-mentioned Coulter Multisizer II model by means of an aperture having an aperture diameter of 100 μm. The number of particles to be measured is 50,000.

For the particle size distribution measured, an accumulation distribution is drawn on the volume in the order of a small diameter in the divided particle ranges (channel). The particle diameter in which the accumulation in volume is 50% is defined as the volume average particle diameter.

### <Method of Measuring the Volume Average Particle Diameter (in the Case where the Particle Diameter to be Measured is Less than 2 μm)>

When the particle diameter to be measured is less than 2 μm, as described above, the volume average particle diameter of particles is measured by means of a laser diffraction particle size distribution measuring apparatus (trade name: LA-700, manufactured by Horiba, Ltd.).

A method of measurement involves preparing about 2 g of a sample in terms of a solid, which is in the form of a dispersion solution, adding ion exchange water thereto to about 40 ml, placing the resulting solution into a cell to an appropriate concentration, allowing it to stand for two minutes, and then measuring the solution in the cell the concentration of which is substantially stable.

A volume average particle diameter obtained for every channel is accumulated in the order of a small volume average particle diameter, and is defined as the volume average particle diameter when the accumulation is 50%.

When a powder such as an external additive is measured, 2 g of a measurement sample is added to 50 ml of a 5% aqueous solution of a surfactant, preferably sodium alkylbenzenesulfonate, and the resulting material is dispersed by means of an ultrasonic dispersing apparatus (1,000 Hz) for two minutes for production of a sample, and then the sample is measured by a method similar to the case of the above-described dispersion solution.

### <Measurement Method of Melting Points and Glass Transition Points>

A glass transition point (Tg) and melting point are determined by means of a differential scanning calorimeter (trade name: DSC-50, manufactured by Shimadzu Corporation) at a heating rate of 3° C. per minute. A glass transition point is defined as the temperature of the intersection of the extension lines of the baseline and the rising line in an endothermic portion, and a melting point is defined as the temperature of the tip of an endothermic peak.

Examples and a comparative example related to a toner 1 for electrostatic charge development of a first embodiment of the invention are depicted hereinafter.

### Example 1

### <Production of Infrared Absorber A>

As raw materials, 4.0 parts by weight of 2,3-dicyano-1-phenylnaphthalene (a compound represented by Structural Formula (2) above), 0.3 parts by weight of vanadyl trichloride, 1.2 parts by weight of 1,8-diazabicyclo[5,4,0]-7-undecene and 20 parts by weight of n-amino alcohol are mixed, and then the resultant material is stirred for 6 hours under heating reflux. After cooled, the resultant mixture is discharged into 100 mL of methanol, and the deposit is filtrated. The deposit is further placed in purified water and boiled and washed, and then purified by column chromatography; a “compound represented by Structural Formula (1)” above is synthesized.

The resultant compound is subjected to acid paste processing and thus micronization processing to a desired particle diameter; Infrared Absorber A is obtained. Specifically, the procedure involves dissolving Infrared Absorber A in 96% concentrated sulfuric acid (the weight 120 times the weight of Infrared Absorber A) for preparation a solution a1, adding this solution a1 dropwise to purified water (25° C., the volume 20 times the volume of the solution a1) that is stirred with a stirrer, so a fine powder of Infrared Absorber A is obtained. The powder is filtrated and washed with purified water and dried for the removal of the remaining sulfuric acid.

The volume average particle diameter of Infrared Absorber A finally obtained is 0.14 μm.

### <Production of Toner A>

First, 2.0 mol of polyoxypropylene(2)-2,2-bis(4-hyroxyphenyl)propane, 1.5 mol of polyoxyethylene(2)-2,2-bis(4-hyroxyphenyl)propane, 2.46 mol of 1,3-butanediol, 0.12 mol of Epicoat 1001 (Japan Epoxy Resin Co. Ltd.), 3.6 mol of terephthalic acid, 1.8 mol of isophthalic acid, 0.1 mol of trimellitic anhydride and 2.3 g of oxidized-n-butyl tin are placed in a 3-litter four-necked glass flask, and the flask is equipped with a thermometer, stirring rod, falling condenser and nitrogen supply tube. The flask is fitted in an electric heating mantle and a reaction is carried out under a nitrogen flow at 220° C. with stirring. When the temperature reaches the softening point 114° C., the polycondensation is complete; a transparent pale yellow-green solid polyester resin exhibiting an acid value of 30 mg/KOH and a softening temperature of 114° C. is obtained.

To the polyester resin as a binder resin, produced in the above manner, are added 0.8% of a calixarene compound (trade name: E-89, Orient Chemical Industries, Ltd.) and 0.5% of Infrared Absorber A and the resultant material is melt kneaded by means of a twin extruder (trade name: PCM-30, Ikegai Corp.). Thereafter, the material is finely pulverized via a pulverizing and classifying apparatus comprised of a jet mill and DS classifying device (manufactured by Nippon Pneumatic MFG. Co., Ltd.); Toner Mother A is obtained.

To 100 parts by weight of Toner Mother A is added 0.35 parts by weight of hydrophobic silica as an external agent (trade name: H-2000, manufactured by Clariant Corp.) by means of a Henschel mixer; Toner A is obtained.

### Example 2

### <Production of Infrared Absorber B>

Infrared Absorber B is obtained in the same manner as in the case of Infrared Absorber A with the exception that ultimizer processing is carried out instead of acid paste processing, as pulverization processing. (Specifically, an aqueous solution of 10 weight % of an infrared absorber and 10 weight % of a dispersing agent (trade name: Newlex Paste H, manufactured by NOF Corporation) is 20 Pass processed (32 minutes) at a pressure of 230 MPa with Ultimizer-HJP-2500; particles are obtained.)

The volume average particle diameter of Infrared Absorber B thus obtained is 0.32 μm.

### <Production of Toner B>

Toner B is obtained in the same manner as in the production of Toner A with the exception that Infrared Absorber B is used instead of Infrared Absorber A.

### Comparative Example 1

### <Production of Infrared Absorber P>

Infrared Absorber P is obtained in the same manner as in the case of Infrared Absorber A with the exception that 2,3-dicyano-1-phenylnaphthalene is changed to 2,3-dicyanonaphthalene, as a raw material of an infrared absorber.

The volume average particle diameter of Infrared Absorber P thus obtained is 0.13 μm.

### <Production of Toner P>

Toner P is obtained in the same manner as in the production of Toner A with the exception that Infrared Absorber P is used instead of Infrared Absorber A.

### [Method of Evaluating a Toner]

The toner (Toner A, B or P) obtained is blended with a styrene/butyl methacrylate Mn—Mg ferrite carrier having an average particle diameter of 40 μm such that the concentration of the toner is 5.5%, so a developer is made. The resultant developer is fed into a remodeled apparatus of a DocuColor 1250 (reference number; manufactured by Fuji Xerox Co., Ltd.), (a configuration in which the developing device for black and color is removed and a developer for an invisible toner is introduced); an image is formed.

In image formation, the equivalent amount of toner (Toners A, B, and P) is used on a recording medium, and a toner unfixed image (inch square solid) is produced by development, and then the resultant recording medium is allowed to stand in an oven at 130° C. for 10 minutes for preparation of a toner fixed image.

For the measurement of the reflectance of a toner fixed image, the region in which a toner fixed image is formed is measured by means of a self-recording spectrophotometer (trade name: U-4100, manufactured by Hitachi High-Technologies Corp. (former Nissei Sangyo Co., Ltd.)), a spectroreflectometer (trade name: V-570, manufactured by JASCO Corp.), or the like.

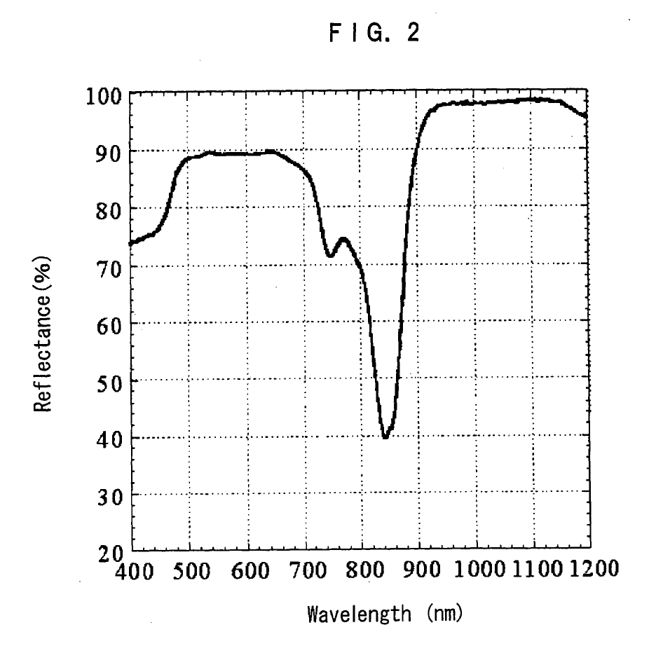

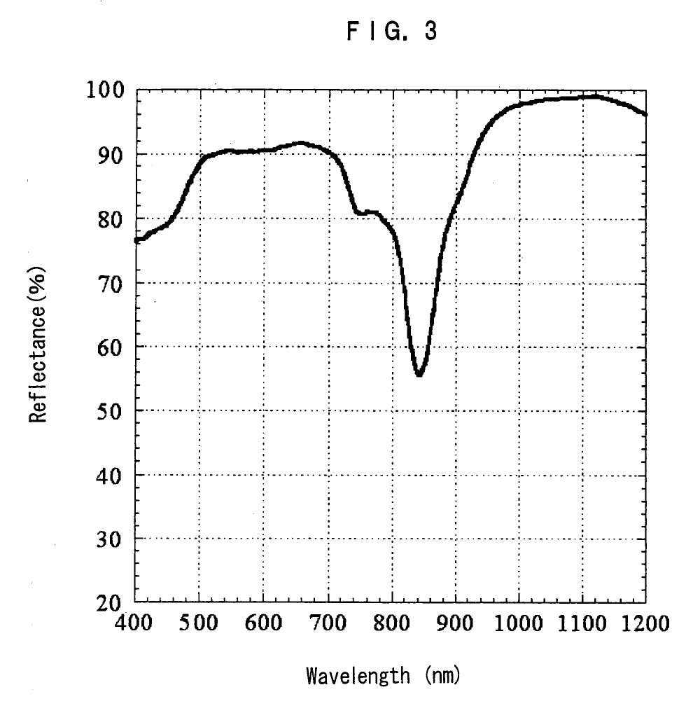

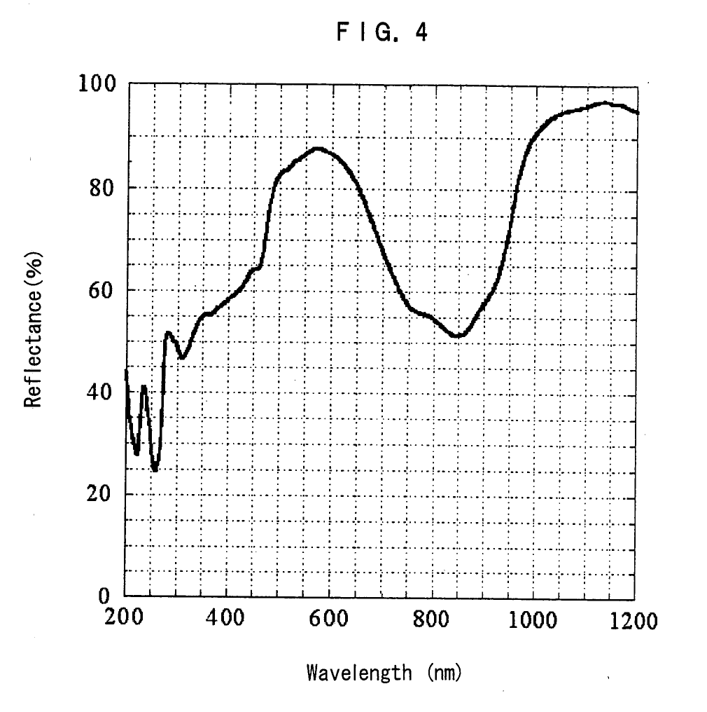

Reflectance spectra of toner fixed images obtained in Examples 1 and 2, and Comparative Example 1 are respectively shown in FIGS. 2 to 4.

As is understood from these results (FIGS. 2 to 4), the examples are capable of keeping the reflectance of the visible region (400 to 700 nm, particularly 400 to 500 nm) high (low in absorbance) even when an image that is low in reflectance (high in absorbance) at a near infrared wavelength of 850 nm is formed, as compared with the comparative example. Hence, in comparison with the comparative example, the examples allow the formation of an image that is hardly visually recognized by humans and readily readable by means of an infrared ray absorbing pattern detector.

Examples and Comparative Examples related to a toner 2 for electrostatic charge development of a second embodiment of the invention are depicted hereinafter.

### Example 3

### <Preparation of Infrared Absorber Dispersion Solution A′>

0.5 Weight part of the above-mentioned infrared absorber “VONPc-Ph” (manufactured by Sigma-Aldrich Inc.), 0.5 weight part of an anionic surfactant (dodecylbenzenesulfonic acid) and 99 parts by weight of ion exchange water are mixed and the resulting solution is dispersed for 10 minutes by means of a homogenizer (trade name: Ultratalux T50, manufactured by IKA Co., Ltd.), followed by a circulating ultrasonic dispersing apparatus (trade name: RUS-600TCVP, manufactured by Nippon Seiki Co., Ltd.); as a result, Infrared Absorber Dispersion Solution A′ is obtained.

The volume average particle diameter of the resultant infrared absorber within Infrared Absorber Dispersion Solution A′ is 0.13 μm, and the solid component ratio of the infrared absorber is 0.5 weight %.

### <Preparation of Resin Particle Dispersion Solution A′>

In a heating dried three-necked flask are placed 65 parts by weight of dimethyl adipate, 183 parts by weight of dimethyl terephthalate, 223 parts by weight of bisphenol A-ethylene oxide additive, 38 parts by weight of ethylene glycol and 0.07 parts by weight of tetrabutoxy titanate, and then the resultant material is subjected to ester exchange reaction by heating at 170 to 220° C. for 180 minutes.

Subsequently, the reaction is continued for 60 minutes at 220° C. at a pressure of from 0.13 to 1.33 kPa (1 to 10 Torr), so Polyester Resin A′ is obtained.

Next, 115 parts by weight of Polyester Resin A′, 180 parts by weight of deionized water, 5 parts by weight of an anionic surfactant (trade name: Neogen RK, manufacture by Dai-Ichi Kogyo Seiyaku Co., Ltd.) are mixed, and the resultant material is heated to 120° C., and then is sufficiently dispersed via a homogenizer (trade name: Ultraturrax T50, manufactured by IKA Co., Ltd.). After the resulting mixture is dispersion processed by means of a pressure discharge Gaulin homogenizer for one hour, Resin Particle Dispersion Solution A′ (resin particle concentration: 40 weight %) is prepared. The volume average particle diameter is 0.24 μm.

### <Preparation of Releasing Agent Dispersion Solution A′>

100 parts by weight of Fischer-Tropsch Wax FNP92 (melting point: 92° C., manufactured by Nippon Seiki Co., Ltd.), 3.6 parts by weight of an anionic surfactant (trade name: Neogen R, Dai-Ichi Kogyo Seiyaku Co., Ltd.) and 400 parts by weight of ion exchange water are mixed and the resultant mixture is heated to 100° C. and then is subjected to sufficient dispersion by means of a homogenizer (trade name: Ultraturrax T50, manufactured by IKA Co., Ltd.), followed by dispersion processing by means of a pressure discharge Gaulin homogenizer, so Releasing Agent Dispersion Solution A′ is obtained.

The volume average particle diameter of the releasing agent within Releasing Agent Dispersion Solution A′ thus obtained is 0.23 μm, and the solid component ratio of Releasing Agent Dispersion Solution A′ is 20 weight %.

### <Production of Toner A′>

295 Parts by weight of Resin Particle Dispersion Solution A′, 36 parts by weight of Infrared Absorber Dispersion Solution A′, 92 parts by weight of Releasing Agent Dispersion Solution A′ and 600 parts by weight of deionized water are placed in a round stainless steel flask and then the resultant solution is mixed and dispersed by an Ultraturrax T50.

Next, 0.36 weight part of polyaluminum chloride is added thereto, and the dispersion operation is continued by means of the Ultraturrax. Additionally, the solution is heated to 30° C. to 52° C. at a 3° C./min while the flask is stirred with a heating oil bath. After the solution is maintained at 52° C. for 3 hours, 140 parts by weight of Resin Particle Dispersion Solution A′ is gently added thereto.

Then, the pH within the system is adjusted to 8.5 with a 0.5 mol/L aqueous sodium hydroxide solution, and then the stainless steel flask is sealed. The solution is heated to 93° C. with continuous stirring by use of a magnetic seal and maintained for 3 hours.

After completion of the reaction, the solution is cooled, filtrated, and sufficiently washed with ion exchanged water, and then the solid and liquid are separated by Nutsche suction filtration. The solid is re-dispersed in 3 L of ion exchanged water at 40° C. and then stirred and washed at 300 rpm for 15 minutes.

This operation is repeated 5 times, and when the pH of the filtrate is 7.00, the electric conductivity thereof is 8.8 μS/cm, and the surface tension thereof is 71.0 Nm, the solid and liquid are separated by Nutsche suction filtration by means of No 5A filter paper. Next, vacuum drying is continued for 12 hours.

### Example 4

### <Production of Toner B′>

Toner B′ is obtained in the same manner as in the production of Toner A′ with the exception that the production conditions of the toner are in the following.

0.36 Weight part is changed to 0.26 weight part, in polyaluminum chloride, and the heating to 52° C. and the maintenance at the temperature for 3 hours are changed to the heating to 54° C. and the maintenance at the temperature for 3 hours.

### Example 5

### <Production of Toner C′>

Toner C′ is obtained in the same manner as in the production of Toner A′ with the exception that the production conditions of the toner are in the following.

The heating at a 3° C./min from 30° C. to 52° C. is changed to the heating at a 2° C./min from 30° C. to 42° C., and then the heating at a 0.5° C./min from 42° C. to 52° C. is carried out.

### Example 6

### <Preparation of Infrared Absorber Dispersion Solution D′>

Infrared Absorber Dispersion Solution D′ is obtained in the same manner as in the preparation of Infrared Absorber Dispersion Solution A′ with the exception that 0.5 weight part of the above-mentioned infrared absorber “VONPc-OnBu” (manufactured by Sigma-Aldrich Inc.) is used instead of the infrared absorber “VONPc-Ph.” The volume average particle diameter is 0.12 μm and the solid component ratio is 0.5 weight %.

### <Production of Toner D′>

Toner D′ is obtained in the same manner as in the production of Toner C′ with the exception that Infrared Absorber Dispersion Solution D′ is used instead of Infrared Absorber Dispersion Solution A′.

### Example 7

### <Preparation of Infrared Absorber Dispersion Solution E′>

Infrared Absorber Dispersion Solution E′ is obtained in the same manner as in the preparation of Infrared Absorber Dispersion Solution A′ with the exception that 0.5 weight part of the above-mentioned infrared absorber “H₂NPc-OnBu” (manufactured by Sigma-Aldrich Inc.) is used instead of the infrared absorber “VONPc-Ph.” The volume average particle diameter is 0.11 μm and the solid component ratio is 0.5 weight %.

### <Production of Toner E′>

Toner E′ is obtained in the same manner as in the production of Toner C′ with the exception that Infrared Absorber Dispersion Solution E′ is used instead of Infrared Absorber Dispersion Solution A′.

### Example 8

### <Preparation of Infrared Absorber Dispersion Solution F′>

Infrared Absorber Dispersion Solution F′ is obtained in the same manner as in the preparation of Infrared Absorber Dispersion Solution A′ with the exception that 0.5 weight part of the above-mentioned infrared absorber “ST173” (manufactured by Sigma-Aldrich Inc.) is used instead of the infrared absorber “VONPc-Ph.” The volume average particle diameter is 0.15 μm and the solid component ratio is 0.5 weight %.

### <Production of Toner F′>

Toner F′ is obtained in the same manner as in the production of Toner C′ with the exception that Infrared Absorber Dispersion Solution F′ is used instead of Infrared Absorber Dispersion Solution A′.

### Comparative Example 2

### <Production of Toner P′>

Toner P′ is obtained in the same manner as in the production of Toner A′ with the exception that the production conditions of the toner are in the following.

0.36 Weight part is changed to 0.30 weight part, in polyaluminum chloride, and the heating from 30° C. to 52° C. at 3° C./min is changed to the heating from 30° C. to 52° C. at 5° C./min.

### Comparative Example 3

### <Preparation of Infrared Absorber Dispersion Solution Q′>

Infrared Absorber Dispersion Solution Q′ is obtained in the same manner as in the preparation of Infrared Absorber Dispersion Solution A′ with the exception that 0.5 weight part of the above-mentioned infrared absorber “VONPc” (manufactured by Yamamoto Chemicals Inc.) is used instead of the infrared absorber “VONPc-Ph.” The volume average particle diameter is 0.12 μm and the solid component ratio is 0.5 weight %.

### <Production of Toner Q′>

Toner Q′ is obtained in the same manner as in the production of Toner A′ with the exception that Infrared Absorber Dispersion Solution Q′ is used instead of Infrared Absorber Dispersion Solution A′.

### [Production of an External Toner]

To 50 parts by weight of the above-described toner produced is added 0.21 weight part of hydrophobic silica (trade name: TS720, manufactured by Cabot Corporation) and the resultant material is blended by means of a sample mill, so an external toner is produced.

### [Preparation of Developer]

Into ferrite carriers with an average particle diameter of 50 μm, having coated thereon 1 weight % of polymethylmethacrylate (Soken Chemical & Engineering Co., Ltd.) is weighed the above-mentioned external toner such that the toner concentration is 5 weight %, and the resultant material is stirred and blended by means of a ball mill for 5 minutes; a developer is prepared.

### [Evaluation Method]

The developer thus obtained is placed into a DocuPrint C2220 (hereinafter sometimes abbreviated as “DPC2220”) manufactured by Fuji Xerox Co., Ltd., and a fixed image is formed.

The image is made of 100 fine lines of 0.2 mm×10 mm arranged at 0.2 mm intervals, that is, in the image, fine lines are aligned horizontally.

The image thus obtained is evaluated in the following. The results are listed in Table 2.

### -Readability Evaluation of a Toner Image Just After the Formation-

The above-described image formed face is irradiated via a ring-shaped LED light source (trade name: LEB-3012CE, manufactured by Kyoto Denki Co., Ltd.) that also emits light in the near infrared wavelength region and disposed 10 cm just above the image formed face. In this state, by means of a CCD camera (trade name: CCD TL-C2, manufactured by KEYENCE Corp.) that is disposed 15 cm right above the image formed face, includes a lens portion having installed therein a filter cutting the wavelength components of 800 nm or less, and has photo-detection sensitivity in the wavelength region of from 800 nm to 1000 nm, the above-mentioned image forming face is read out, and separated into two regions of values at a boundary of a specified contrast (threshold) and the image is extracted. This image is decoding processed by software and 100 images are confirmed whether or not reading is possible. The image is good if the readability is 85% or more, is better if it is 95% or more.

### -Readability Evaluation of a Toner Image in a Lapse of Time (after 60 Days)-

An image is exposed to light 50 cm just below a fluorescent lamp of 100 lux for 60 days, and the same readability evaluation is carried out as the readability evaluation of an image just after its formation.

TABLE 2

| | | Toner | | Readability of a | |
|---|---|---|---|---|---|
| | | Volume average | | toner image (%) | |
| | Infrared absorber | particle diameter | | Just after image | In a lapse of time |
| | species | (μm) | GSD_{V} value | formation | (after 60 days) |
| Example 3 | VONPc-Ph | 6.0 | 1.24 | 100 | 90 |
| Example 4 | VONPc-Ph | 5.7 | 1.22 | 100 | 94 |
| Example 5 | VONPc-Ph | 5.6 | 1.19 | 100 | 96 |
| Example 6 | VONPc-OnBu | 5.8 | 1.23 | 100 | 88 |
| Example 7 | H₂NPc-OnBu | 5.7 | 1.22 | 100 | 89 |
| Example 8 | ST173 | 5.8 | 1.23 | 100 | 88 |
| Comparative | VONPc-Ph | 6.0 | 1.28 | 100 | 81 |
| Example 2 | | | | | |
| Comparative | VONPc | 6.1 | 1.23 | 95 | 79 |
| Example 3 | | | | | |

The results of Table 2 show that Examples are capable of forming infrared absorber images which are good in readability and the readability of which is hardly deteriorated in a lapse of time, as compared with Comparative Examples.

All publications, patent applications, and technical standards mentioned in this specification are herein incorporated by reference to the same extent as if each individual publication, patent application, or technical standard was specifically and individually indicated to be incorporated by reference.

What is claimed is:

1. A toner for electrostatic charge development comprising a binder resin and at least one infrared absorber, wherein at least one of the infrared absorbers is a compound represented by the following Structural Formula (1).

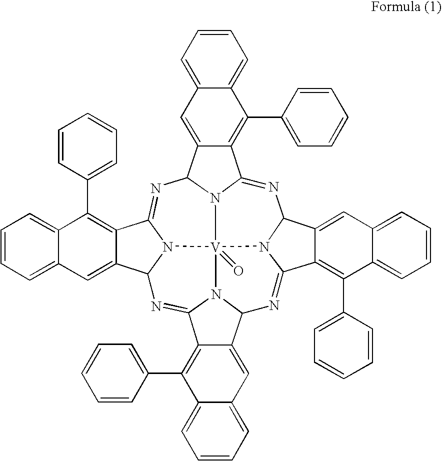

2. The toner for electrostatic charge development of claim 1, wherein the volume average particle diameter of the infrared absorber is 0.3 μm or less.

3. The toner for electrostatic charge development of claim 1, wherein the volume average particle diameter of the infrared absorber is 0.05 μm or more and 0.2 μm or less.

4. The toner for electrostatic charge development of claim 1, wherein the content of the infrared absorber is 0.1 mass % or more and 2 mass % or less.

5. The toner for electrostatic charge development of claim 1, wherein the content of the infrared absorber is 0.2 mass % or more and 1 mass % or less.

6. The toner for electrostatic charge development of claim 1, wherein the infrared absorber undergoes acid paste processing.

7. The toner for electrostatic charge development of claim 1, wherein the glass transition point (Tg) of the binder resin is from 50 to 120° C.

8. The toner for electrostatic charge development of claim 1, wherein the toner includes a releasing agent.

9. The toner for electrostatic charge development of claim 8, wherein the melting point of the releasing agent is 50° C. or more.

10. The toner for electrostatic charge development of claim 8, wherein the content of the releasing agent is 3 to 20 parts by weight based on 100 parts by weight of the binder resin.

11. The toner for electrostatic charge development of claim 1, wherein the toner includes inorganic particles in the range of 0.01 parts by weight to 5 parts by weight based on 100 parts by weight of toner particles.

12. The toner for electrostatic charge development of claim 11, wherein the primary particle diameter of the inorganic particles (volume average particle diameter) is in the range of from 1 nm to 200 nm.

13. The toner for electrostatic charge development of claim 1, wherein the volume average particle diameter (D50v) of the toner is 3 μm or more and 10 μm or less.

14. The toner for electrostatic charge development of claim 1, wherein the shape factor SF1 of toner particles is in the range of from 110 to 135.

15. A developer for electrostatic charge development comprising the toner for electrostatic charge development of claim 1 and a carrier.

16. The developer for electrostatic charge development of claim 15, wherein the volume average particle diameter of a core of the carrier is in the range of from 10 to 500 μm.

17. A developer cartridge for electrostatic charge development that is attachable to and detachable from an image forming apparatus and at least houses a developer for being supplied to a developing unit provided within the image forming apparatus, wherein the developer comprises the developer for electrostatic charge development of claim 15.

18. An image forming apparatus, comprising at least:
an electrostatic latent image supporter;
a charging unit for charging a surface of the electrostatic latent image supporter;
an electrostatic latent image forming unit for forming an electrostatic latent image on the surface of the electrostatic latent image supporter;
a developing unit for forming a toner image by developing the electrostatic latent image with a developer;
a transfer unit for transferring the toner image to a recording medium; and
a fixing unit for fixing the toner image on the recording medium,
wherein the developer comprises the developer for electrostatic charge development of claim 15.

19. A toner for electrostatic charge development comprising a binder resin and at least one infrared absorber, wherein at least
one of the infrared absorbers exhibits a maximum absorption in the wavelength range of from 750 nm to 1100 nm, both inclusive,
the full width at half maximum of the maximum absorption is 100 nm or less, and
the volume average particle distribution index GSD_{V} represented by the following Equation (1) is 1.25 or less:
GSD_{V}=(D_{84V}/D_{16V})^{1/2} Equation (1)
wherein D_{84V} is a particle diameter value at which the accumulation from the small diameter side of the toner particle diameter distribution is 84%, and D_{16V} is a particle diameter value at which the accumulation from the small diameter side of the toner particle diameter distribution is 16%.

20. The toner for electrostatic charge development of claim 19, wherein
the maximum absorption is in the wavelength range of from 800 nm to 1000 nm, both inclusive.

21. A developer for electrostatic charge development, comprising the toner for electrostatic charge development of claim 19.

22. A developer cartridge for electrostatic charge development that is attachable and detachable to and from an image forming apparatus and at least houses a developer for being supplied to a developing unit provided within the image forming apparatus, wherein
the developer is the developer for electrostatic charge development of claim 21.

23. An image forming apparatus comprising at least:
an electrostatic latent image supporter;
a charging unit for charging a surface of the electrostatic latent image supporter;
an electrostatic latent image forming unit for forming an electrostatic latent image on the surface of the electrostatic latent image supporter;
a developing unit for forming a toner image by developing the electrostatic latent image with a developer;
a transfer unit for transferring the toner image to a recording medium; and
a fixing unit for fixing the toner image on the recording medium,
wherein
the developer comprises the developer for electrostatic charge development of claim 21.
